(19) United States
(12) Patent Application Publication
(10) Pub. No.: US 2002/0085505 A1
(43) Pub. Date: Jul. 4, 2002

(54) Communication control unit and communication control method

(76) Inventor: Tomokazu Suda, Kanagawa (JP)

Correspondence Address: FROMMER LAWRENCE & HAUG LLP, 745 FIFTH AVENUE, NEW YORK, NY, 10151, US

(21) Appl. No.: 09/995,289

(22) Filed: Nov. 26, 2001

(30) Foreign Application Priority Data
Nov. 27, 2000 (JP) 2000-359703

(51) Int. Cl. H04L 12/26

(52) U.S. Cl. 370/253; 370/465

(57) ABSTRACT

In the event of a bus-reset, the transmission-speed-setting means sets a predetermined transmission speed and stores the predetermined transmission speed in a transmission-speed storage means. Then, the SP-extracting means receives a self-ID packet from another node by way of the bus, the physical layer and the LINK layer. The SP-extracting means extracts information on a transmission speed (SP) from the packet, and supplies the SP to the transmission-speed-setting means. The transmission-speed-setting means compares the SP with the transmission speed stored in the transmission-speed storage means to select an optimum transmission speed and, if necessary, uses the optimum transmission speed to update the stored transmission speed. The extraction of an SP, the comparison of the SP with a stored transmission speed and an operation to update the stored transmission speed if necessary are carried out every time a self-ID packet is received.

### BACKGROUND OF THE INVENTION

The present invention relates to a communication control unit and a communication control method. More particularly, the present invention relates to a communication control unit mounted on an information-processing apparatus communicating with other equipment through a network and relates to a communication control method adopted by the communication control unit.

Conventionally, in an information-processing apparatus connected to a network such as a serial bus, data is exchanged between the apparatus and other equipment by way of the network at a transmission speed adjusted to capabilities of the apparatus and the other equipment.

An information-processing apparatus connected to a serial bus as such includes an embedded special communication control unit. Processing at physical and data-link layers is carried out by hardware of the information-processing apparatus. In general, the communication control unit is embedded in the information-processing apparatus as an LSI chip. On the other hand, application processing is carried out by an upper-level microprocessor also mounted on the information-processing apparatus. The upper-level microprocessor is referred to hereafter as a host.

Processing from initialization of the serial bus to setting of a transmission speed is explained as an example conforming to IEEE-1394 specifications. FIG. 5 shows timing charts of processing, which is carried out after the conventional bus-reset according to the IEEE-1394 specifications.

In accordance with the IEEE-1394 specifications, a bus-reset occurs due to connection of an apparatus such as a digital video camera to an IEEE-1394 bus. A digital video camera is abbreviated hereafter to merely a DV. An apparatus connected to the IEEE-1394 bus is referred to hereafter as a node. When a bus reset occurs, each node automatically resets its topology, and transmits a self-ID packet. A self-ID packet of a node is a packet containing a self_ID uniquely assigned to the node. As shown in FIG. 5, a self_ID1 packet, a self_ID2 packet and a self_ID3 packet are sequentially transmitted through the IEEE-1394 bus serving as part of a physical layer employed in a node one packet after another from respectively an apparatus 1, an apparatus 2 and an apparatus 3, which are not shown in the figure. At a LINK layer employed in the node, the self_ID1 packet, the self_ID2 packet and the self_ID3 packet, which are received from the physical layer, are sequentially processed one packet after another and then transferred to a host of the same node. The host in each node stores the processed self_IDs in a storage area in the host. A self_ID packet transmitted by a last node is followed by a sub-action gap (SG). Following the first sub-action gap, data can be exchanged between the node and another node.

In the above example, the last node is the apparatus 3. During a period between the transmission of the self_ID3 packet from the apparatus 3 and the sub-action gap, the host of the node 1 analyzes the self_IDs of other nodes, namely, the nodes 2 and 3. In addition to a number assigned to the node, a self_ID peculiar to a node includes SP information indicating a maximum transmission speed that the node is capable to keep up with. The host thus identifies a transmission speed of each node from the SP information of the node, and sets an optimum transmission speed. In a transmission of a packet, a transmission speed which has been set is supplied to a serial-bus controller for controlling the IEEE-1394 serial bus with a speed code. The packet is thus transferred through the IEEE-1394 serial bus at a transmission speed determined by the speed code.

Since a host of a node analyzes transmission speeds of other nodes in accordance with the conventional technology as described above, however, there is raised a problem of an increased processing load to be borne by the host.

As described above, the host has a storage area for storing self_IDs of nodes and must analyzes the self_IDs during a period between the transmission of a self_ID from the last node and the issuance of a sub-action gap. For this reason, in the first place, in the case of a serial bus connectable to a number of apparatuses, the host employed in each of the apparatuses must preserve a storage area for storing the self_IDS of other apparatuses. In the second place, during a period of about 10 microseconds between the transmission of a self_ID from the last node and the issuance of a sub-action gap, the self_IDs must all be analyzed. Since the processing load borne by the host increases considerably, however, it will be difficult to bear such a processing load by using a less powerful host.

In addition, if the analysis of the self_IDs is not completed before the first sub-action gap, data must be exchanged at a lowest transmission speed, causing the band to be wasted.

### SUMMARY OF THE INVENTION

It is thus an object of the present invention addressing the problems described above to provide a communication control unit capable of reducing a processing load borne by a host to analyze transmission speeds of nodes.

In order to solve the problems described above, in accordance with an aspect of the present invention, there is provided a communication control unit mounted on an information-processing apparatus communicating with other apparatuses each serving as a node of a network through the network connecting the apparatuses with each other and used for controlling communications between the information-processing apparatus with the other apparatuses through the network. The communication control unit includes a transmission-speed storage means for storing a transmission speed at which data is to be communicated with other nodes connected to the network, a transmission-speed-information-acquiring means for acquiring transmission-speed information on a transmission speed set in another node connected to the network for communicating data from the other node and a transmission-speed-setting means for setting a predetermined transmission speed in the transmission-speed storage means in advance, comparing the predetermined transmission speed set in the transmission-speed storage means in advance with the acquired transmission-speed information on a transmission speed set in another node connected to the network and carrying out transmission-speed-setting/updating processing to update a transmission speed stored in the transmission-speed storage means on the basis of a result of comparison.

In order to solve the problems described above, in accordance with another aspect of the present invention, there is provided a communication control method adopted by a communication control unit mounted on an information-processing apparatus communicating with other apparatuses each serving as a node of a network through the network connecting the apparatuses with each other and used for controlling communications between the information-processing apparatus with the other apparatuses through the network. The communication control method includes the steps of setting a transmission speed at which data is to be communicated with other nodes connected to the network in advance, acquiring transmission-speed information on a transmission speed set in another node connected to the network for communicating data from the other node, comparing the predetermined transmission speed set in advance with the acquired transmission-speed information on a transmission speed set for communicating data in the other node, selecting an optimum transmission speed in accordance with a result of comparison and, if necessary, setting the selected optimum transmission speed to update the predetermined transmission speed set in advance and repeatedly carrying out the processing starting with the step of acquiring transmission-speed information on a transmission speed if there is a further node, from which transmission-speed information on a transmission speed has not been acquired.

As described above, in a communication control unit provided by the present invention, a predetermined transmission speed is set in advance. The communication control unit is employed in a data-processing apparatus serving as a node connected to a network. The communication control unit receives information on a transmission speed from another node connected to the network. Every time information on a transmission speed of another node is received from the other node, the transmission speed is compared with the predetermined transmission speed to select either the transmission speed or the predetermined transmission speed stored in advance as an optimum transmission speed. If necessary, the selected optimum speed is used as a replacement of the predetermined transmission speed stored beforehand.

In an information-processing apparatus incorporating such a communication control unit, it is the control unit that selects an optimum transmission speed as described above. Thus, a storage area for storing information used for determining an optimum transmission speed is not required in the host. In addition, it is also no longer necessary for the host to analyze received transmission speeds in order to determine an optimum transmission speed during a short period of time between a transition of processing to the host and a start of communication. As a result, the processing load borne by the host can be reduced substantially. Moreover, since an optimum transmission speed can be determined during a predetermined period of time, data can be communicated at the optimum transmission speed right after the completion of the initialization of the bus. Thus, the transmission band can be utilized with a high degree of efficiency.

Furthermore, a communication control method provided by the present invention includes the steps of setting a transmission speed at which data is to be communicated with other nodes connected to the network in advance, acquiring transmission-speed information on a transmission speed set in another node connected to the network for communicating data from the other node, comparing the predetermined transmission speed set in advance with the acquired transmission-speed information on a transmission speed set for communicating data in the other node and selecting an optimum transmission speed in accordance with a result of comparison and, if necessary, setting the selected optimum transmission speed to update the predetermined transmission speed set in advance. If there is a further node, from which transmission-speed information on a transmission speed set for communicating data in the further node has not been acquired, the steps of the method are again executed for this further node, starting with the step of acquiring transmission-speed information on a transmission speed set for communicating data in the further node. This processing is carried out repeatedly for all other nodes connected to the network.

In an information-processing apparatus incorporating such a communication control unit, it is the control unit that selects an optimum transmission speed as described above. Thus, a storage area for storing information used for determining an optimum transmission speed is not required in the host. In addition, it is also no longer necessary for the host to analyze received transmission speeds in order to determine an optimum transmission speed during a short period of time between a transition of processing to the host and a start of communication. As a result, the processing load borne by the host can be reduced substantially.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

FIG. 1 is a block diagram showing the configuration of a network connecting data transmission apparatuses each incorporating a communication control unit implemented by an embodiment of the present invention;

FIG. 2 is a diagram showing the configuration of an IEEE-1394 self_ID packet;

FIG. 3 is a flowchart representing the communication control method adopted by the communication control unit implemented by the embodiment of the present invention;

FIG. 4 shows timing charts of post-bus-reset operations carried out by the communication control unit provided by the present invention; and

FIG. 5 shows timing charts of processing, which is carried out after the conventional bus reset according to the IEEE-1394 specifications.

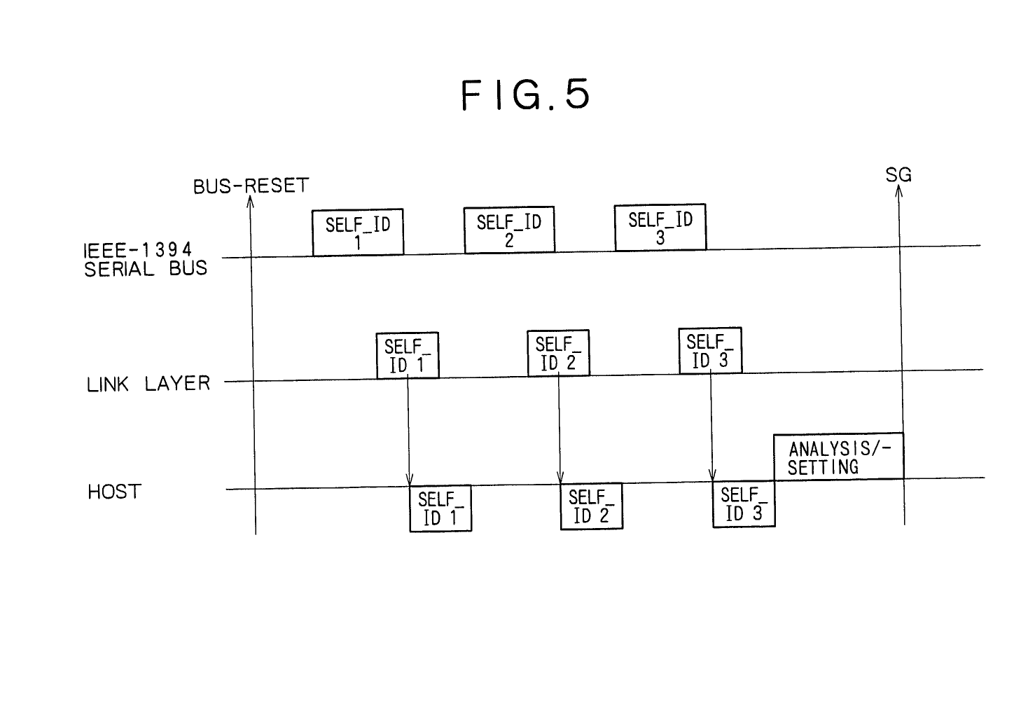

### DETAILED DESCRIPTION OF THE PREFERRED EMBODIMENT

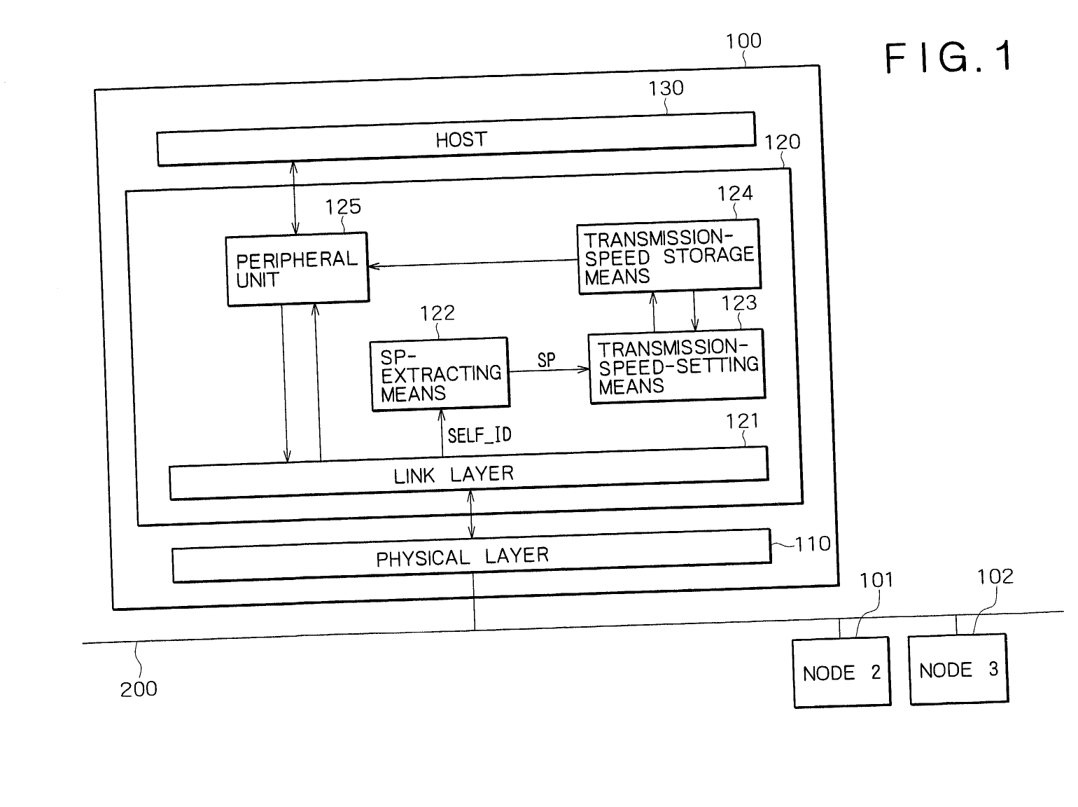

A preferred embodiment of the present invention is explained by referring to diagrams. A network in the embodiment is an IEEE-1394 serial bus. FIG. 1 is a block diagram showing the configuration of a network connecting data transmission apparatuses each incorporating a communication control unit implemented by an embodiment of the present invention.

A data transmission apparatus 100 (or node 1) incorporating a communication control unit implemented by the embodiment of the present invention composes a network in conjunction with other nodes 2 and 3, which are connected to node 1 by an IEEE-1394 serial bus 200 referred to hereafter simply as a bus. In the figure, nodes 2 and 3 are denoted by reference numerals 101 and 102 respectively. The internal configurations of nodes 2 and 3 are each identical with the data transmission apparatus 100 (node 1).

The data transmission apparatus 100 (node 1) is typically an information-processing apparatus such as a DV or a personal computer. Information such as data representing a moving picture is exchanged among the nodes through the bus 200. The data transmission apparatus 100 includes a physical layer 110, a communication control unit 120 and a host 130. The physical layer 110 carries out processing prescribed for a physical layer by the IEEE-1394 specifications. The communication control unit 120 carries out communication control processing including processing prescribed for a data-link layer by the IEEE-1394 specifications. The host 130 carries out application processing. The communication control unit 120 includes a LINK layer 121, a transmission speed-information-extracting means 122 for extracting transmission speed information abbreviated hereafter to an SP, a transmission speed-setting means 123, a transmission speed storage means 124 and a peripheral unit 125.

A data packet coming through the bus 200 is passed on to the communication control unit 120 employed in the data transmission apparatus 100 (node 1) by way of the physical layer 110, being received by the LINK layer 121 employed in the communication control unit 120. As described above, the physical layer 110 carries out signal processing prescribed for a physical layer by the IEEE-1394 specifications. On the other hand, the LINK layer 121 carries out signal processing prescribed for a data-link layer by the IEEE-1394 specifications. In accordance with the IEEE-1394 specifications, a bus-reset is generated by a node recognizing connection of a new apparatus to the bus 200, disconnection of an existing apparatus from the bus 200 or a similar change in the configuration of the bus 200. In the event of a bus-reset, each node automatically recognizes the topology, sets a node address or a node number and outputs a self_ID packet to the bus 200. A self_ID packet transmitted after a bus-reset by node 2 (or the data transmission apparatus 101) or node 3 (or the data transmission apparatus 102), both of which are connected to the bus 200, is supplied to the SP-extracting means 122 by way of the physical layer 110 and the LINK layer 121.

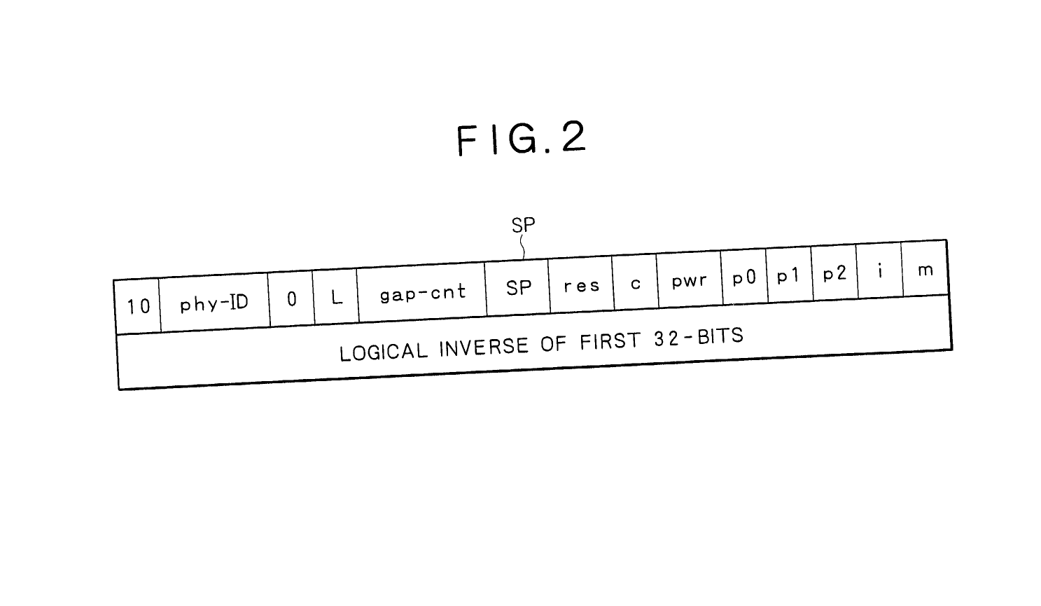

The self_ID packet is explained as follows. FIG. 2 is a diagram showing the configuration of an IEEE-1394 self_ID packet.

A self_ID packet of a node contains node identification information for identifying each node. The self_ID packet includes a node number (phy_ID), the existence/nonexistence of a LINK layer (L), an inter-packet gap (gap_cnt) and transmission-speed information (SP). An SP used in the present invention is explained below. Explanation of the other information is omitted.

An SP of a node represents a maximum transmission speed that the node is capable of keeping up with. In accordance with the IEEE-1394 specifications, at present, a transmission speed can be set at 100 Mbps, 200 Mbps or 400 Mbps. The SP is 2 bits set at “00b”, “01b” or “10b” to represent a transmission speed of 100 Mbps, 200 Mbps or 400 Mbps respectively. For example, a node having an SP of “00b” is capable of communicating only at a transmission speed of 100 Mbps. A node having an SP of “01b” is capable of communicating at a transmission speed of 200 Mbps or 100 Mbps. A node having an SP of “10b” is capable of communicating at a transmission speed of 400 Mbps, 200 Mbps or 100 Mbps.

Referring back to FIG. 1, the SP-extracting means 122 is a transmission-speed-information-acquiring means for acquiring the transmission-speed information of another node. To put it in detail, the SP-extracting means 122 is a transmission-speed-information-extracting means for extracting an SP from a self_ID packet which includes node identification information received by a node-identification-information-receiving means including the physical layer 110 and the LINK layer 121. Each time a self_ID packet coming through the bus 200 is passed on to the communication control unit 120 by way of the physical layer 110, being received by the LINK layer 121 employed in the communication control unit 120, the SP-extracting means 122 extracts an SP described above from the self_ID packet and supplies the extracted SP to the transmission-speed-setting means 123.

The transmission-speed-setting means 123 sets a predetermined transmission speed and stores the speed in the transmission-speed-storing means 124 in advance. Each time an SP is received from the SP-extracting means 122, the transmission-speed-setting means 123 compares the SP with the predetermined transmission speed stored in the transmission-speed-storing means 124 in advance, selects an optimum transmission speed and, if necessary, stores the optimum transmission speed in the transmission-speed-storing means 124 to update the set transmission speed stored in the transmission-speed-storing means 124 in advance. An optimum transmission speed can be selected arbitrarily by adoption of a technique proper for the network. If the network is a serial bus, for example, a lowest transmission speed that a node connected to the serial bus is selected as an optimum transmission speed. To be more specific, the transmission-speed-setting means 123 compares the SP with the predetermined transmission speed stored in the transmission-speed-storing means 124 in advance and, if the transmission speed specified by the SP is found lower than the predetermined transmission speed stored in the transmission-speed-storing means 124 in advance, the transmission speed specified by the SP is selected and stored in the transmission-speed-storing means 124 to replace the set transmission speed stored in the transmission-speed-storing means 124.

The transmission-speed-storing means 124 is a storage area used for storing a transmission speed set by the transmission-speed-setting means 123. At the start of processing carried out by the transmission-speed-setting means 123, a predetermined transmission speed is set and stored in the transmission-speed-storing means 124 in advance. Each time a self_ID packet is received from another node, however, the transmission speed stored in the transmission-speed-storing means 124 is replaced by a selected optimum transmission speed provided that the selected optimum transmission speed is lower than the transmission speed stored in the transmission-speed-storing means 124. After a self_ID packet is received from a last node, a final transmission speed optimum for the network should have been set in the transmission-speed-storing means 124.

The peripheral unit 125 facilitates exchanges of data between the host 130 and the communication control unit 120 in general and between the host 130 and the LINK layer 121 employed in the communication control unit 120 in particular.

The host 130 carries out application processing and controls the data transmission apparatus 100 (node 1) as a whole. The host 130 is capable of obtaining an optimum transmission speed stored in the transmission-speed-storing means 124 through the peripheral unit 125. In addition, the host 130 issues a command to the LINK layer 121 by way of the peripheral unit 125.

The operation of the data transmission apparatus 100 (node 1) having such a configuration is explained as follows. In the event of a bus-reset, the communication control unit 120 employed in the data transmission apparatus 100 (node 1) is informed of the bus-reset. At that time, the transmission-speed-setting means 123 sets and stores a predetermined transmission speed in the transmission-speed-storing means 124. When a self_ID packet is received from another node connected to the bus 200, the self_ID packet is supplied to the SP-extracting means 122 by way of the physical layer 110 and the LINK layer 121. An example of the other node is the data transmission apparatus 101 (node 2) or the data transmission apparatus 102 (node 3). The SP-extracting means 122 extracts an SP from the received self_ID packet and supplies the SP to the transmission-speed-setting means 123. The transmission-speed-setting means 123 compares the SP with the predetermined transmission speed stored in the transmission-speed-storing means 124 and selects an optimum transmission speed. If necessary, the transmission-speed-setting means 123 stores the selected optimum transmission speed in the transmission-speed-storing means 124 to replace the predetermined transmission speed stored in the transmission-speed-storing means 124 in advance. Assume that an optimum method for selecting a lowest transmission speed is adopted. In this case, if the transmission speed specified by the SP is found lower than the predetermined transmission speed stored in the transmission-speed-storing means 124 in advance, the transmission speed specified by the SP is selected and stored in the transmission-speed-storing means 124 to replace the set transmission speed stored in the transmission-speed-storing means 124 in advance. Each time a self_ID packet is received from another node, the SP-extracting means 122 extracts an SP from the self_ID packet whereas the transmission-speed-setting means 123 analyzes the SP and, if necessary, updates the transmission speed stored in the transmission-speed-storing means 124. This processing is carried out for each received self ID packet. When the last self_ID packet is received and the transmission-speed-setting means 123 determines a transmission speed based on the SP extracted from the packet, a transmission speed optimum for the network 200 is stored in the transmission-speed-storing means 124. Thereafter, a packet is transmitted at the optimum transmission speed stored in the transmission-speed-storing means 124.

As described above, since it is the communication control unit 120 that carries out the processing to analyze transmission-speed information received from each node and set a transmission speed optimum for the bus 200 as a result of the analyses, the processing load borne by the host 130 can be reduced considerably. In addition, since the processing to set a transmission speed is carried out every time a self_ID packet is received from another node, the processing can be completed before a sub-action gap. Thus, packets can be transmitted at a transmission speed optimum for the bus 200 from the beginning.

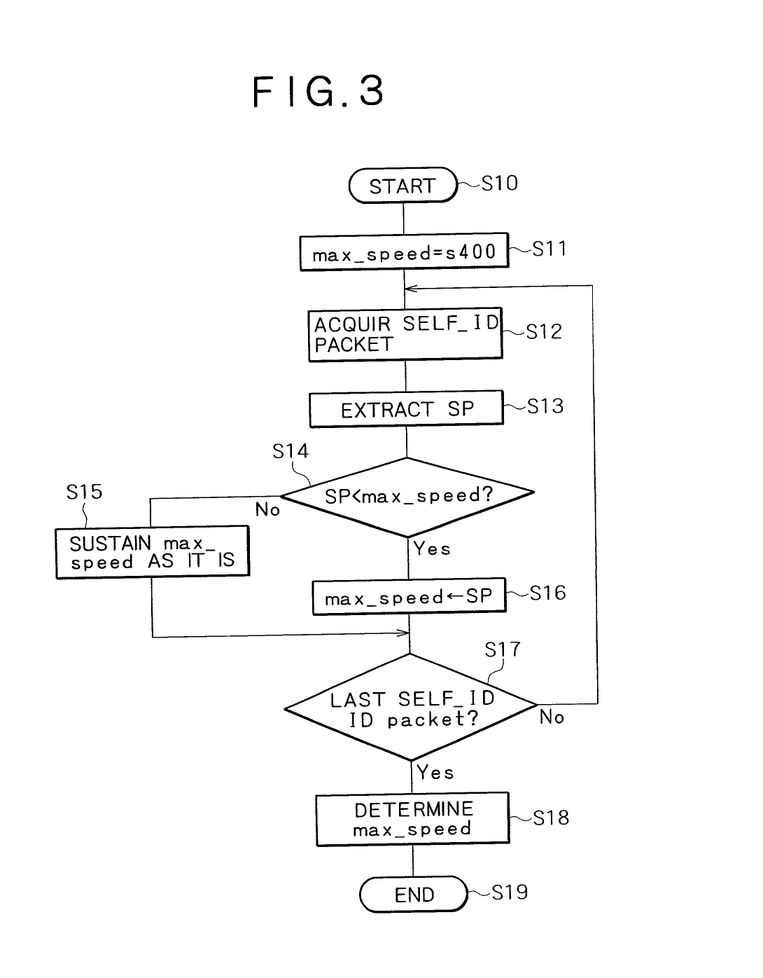

Next, a communication control method adopted by the communication control unit provided by the present invention is explained. FIG. 3 is a flowchart representing the communication control method adopted by the communication control unit implemented by the embodiment of the present invention. The communication control method is used for selecting a highest transmission speed allowed for the node including the communication control unit. Without adoption of this communication control method, the node would otherwise communicate data at a transmission speed lowest among a transmission speed of 100 Mbps, a transmission speed of 200 Mbps and a transmission speed of 400 Mbps, which are referred to hereafter as s100, s200 and s400 transmission speeds respectively.

In the event of a bus-reset, the communication control unit 120 starts processing at the first step S10 of the flowchart shown in FIG. 3. First of all, at the next step S11, the predetermined s400 transmission speed is set in a register called max_speed. The max_speed register serves as the transmission-speed-storing means 124. Then, at the next step S12, a self_ID packet is received from another node. Subsequently, at the next step S13, an SP is extracted from the self_ID packet. Then, at the next step S14, the SP is compared with the s400 transmission speed stored in the max_speed register. If the s400 transmission speed stored in the max_speed register is found equal to or lower than the SP, the flow of the communication control method goes on to a step S15 at which the s400 transmission speed is sustained in the max_speed register as it is. If the SP is found lower than the s400 transmission speed stored in the max_speed register, on the other hand, the flow of the communication control method goes on to a step S16 at which the s400 transmission speed stored in the max_speed register is replaced by the SP.

To put it concretely, if the transmission speed stored in the max_speed register and the SP are both s400, the s400 transmission speed stored in the max_speed register is sustained as it is. If the transmission speed stored in the max_speed register is s400 but the SP is s200 or s100, on the other hand, the s400 transmission speed stored in the max_speed register is replaced by the SP. If the transmission speed stored in the max_speed register is s200 but the SP is s400 or s200, the s200 transmission speed stored in the max_speed register is sustained as it is. If the transmission speed stored in the max_speed register is s200 but the SP is s100, on the other hand, the s200 transmission speed stored in the max_speed register is replaced by the SP. If the transmission speed stored in the max_speed register is s100, the s100 transmission speed stored in the max_speed register is never updated.

Then, at the next step S17, the self_ID packet is examined to form a judgment as to whether or not the packet has been received from a last node. If the self_ID packet is not a packet received from the last node, the flow of the communication control method goes back to the step S12 to receive another self_ID packet. If the self_ID packet is a packet received from the last node, on the other hand, the flow of the communication control method goes on to a step S18 at which the transmission speed stored in the max_speed register is adopted as the optimum transmission speed. Then, at the next step S19, the processing is ended. An operation to update the optimum transmission speed stored in the max_speed register is inhibited till the next initialization of the bus 200.

As described above, since it is the communication control unit 120 that carries out the processing to analyze transmission-speed information received from each node and set a transmission speed optimum for the bus 200 as a result of the analyses, the processing load borne by the host 130 can be reduced considerably. In addition, since the storage area for analyzing an SP and determining a final optimum transmission speed is implemented by the max_speed register for storing a tentative optimum transmission speed, a large storage area is not required for analyzing an SP and determining a final optimum transmission speed in the communication control unit 120. It is needless to say that such a large storage area is not required either in the host 130.

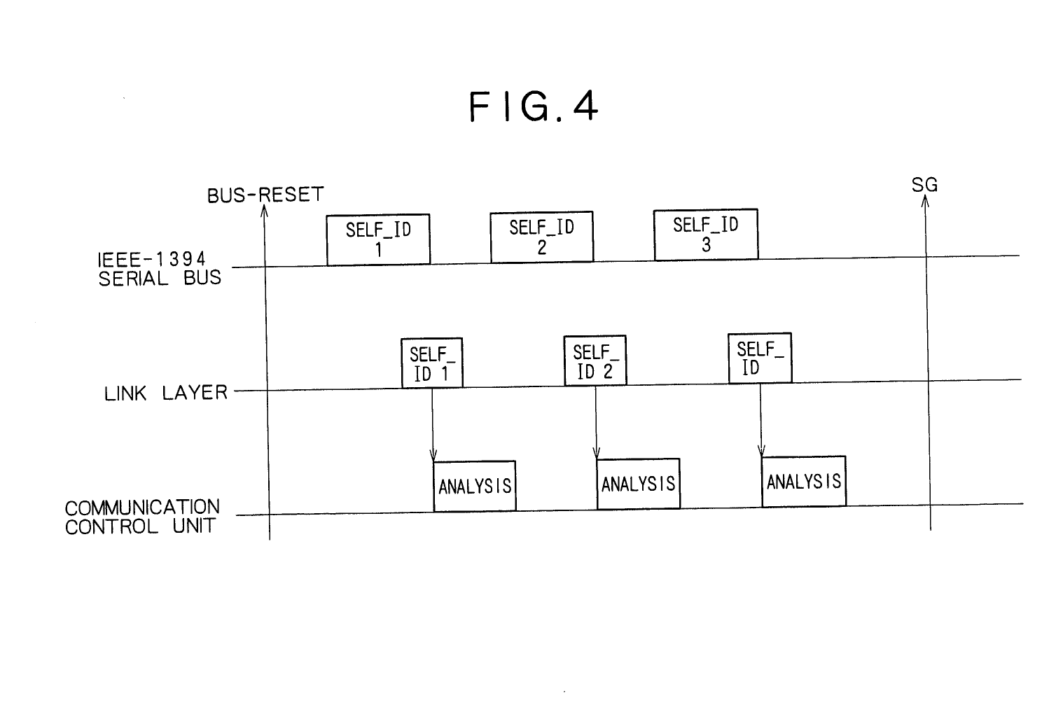

The next description explains operations, from the bus initialization to the processing to set an optimum transmission speed, which are carried out by a data transmission apparatus incorporating the communication control unit provided by the present invention. FIG. 4 shows timing charts of post-bus-reset operations carried out by the communication control unit provided by the present invention.

In the event of a bus-reset, each node automatically recognizes a topology and transmits a self_ID packet. As shown in FIG. 4, a self_ID1 packet, a self_ID2 packet and a self_ID3 packet are sequentially transmitted one packet after another from respectively an apparatus 1, an apparatus 2 and an apparatus 3, which are not shown in the figure. The LINK layer 121 employed in the communication control unit 120 sequentially receives the self_ID1 packet, the self_ID2 packet and the self_ID3 packet from the physical layer 110, supplying the packets to the transmission-speed-information-extracting means 122 employed in the communication control unit 120 one packet after another. Every time a self_ID packet is received, an SP is extracted from the packet. The SP is analyzed and, if necessary, the SP is used for replacing a tentative optimum transmission speed stored beforehand. After the self_ID3 packet, which is the last received self_ID packet, is analyzed for use as a possible replacement of a tentative optimum transmission speed stored beforehand, a final transmission speed optimum for transmission of data among nodes, namely, the apparatuses 1, 2 and 3 connected to the bus 200 is determined.

Since the communication control unit 120 analyzes an SP every time a self_ID packet is received as described above, determination of a final optimum transmission speed can be completed before a sub-action gap (SG) . As a result, data can be transmitted at an optimum transmission speed from the beginning starting with the first transmitted packet without the need for the host 130 to bear a processing load to determine a final transmission speed. In addition, since data can be exchanged at the optimum transmission speed right after the initialization of the bus, the transmission band can be utilized with a high degree of efficiency.

As described above, the network is a serial bus conforming to the IEEE-1394 specifications. However, the scope or the present invention is not limited to such a bus.

It should be noted that the processing functions described above can be executed by a computer. In this case, processing details of all the functions of the communication control unit are prescribed in advance by programs stored in a storage medium readable by the computer. The computer then executes the programs to carry out the functions. Examples of the storage medium readable by the computer are a magnetic recording device and a semiconductor memory. A program sold in the market is normally stored in a portable recording medium such as a CD-ROM (Compact-Disk Read-Only Memory) or a floppy disk. Such a program can also be downloaded into a storage unit employed in the computer by way of a network to which the computer is connected. The program can also be transferred from the computer to another computer by way of the network. When the computer executes a program, the program is loaded from the storage unit such as a hard disk to a main memory of the computer.

While a preferred embodiment of the present invention has been described using specific terms, such description is for illustrative purposes only, and it is to be understood that changes and variations may be made without departing from the spirit or scope of the following claims.

What is claimed is:

1. A communication control unit mounted on an information-processing apparatus communicating with other apparatuses each serving as a node of a network through said network connecting said apparatuses with each other and used for controlling communications between said information-processing apparatus with said other apparatuses through said network, said communication control unit comprising:
a transmission-speed storage means for storing a transmission speed at which data is to be communicated with other nodes connected to said network;
a transmission-speed-information-acquiring means for acquiring transmission-speed information on a transmission speed set in another node connected to said network for communicating data from said other node; and
a transmission-speed-setting means for setting a predetermined transmission speed in said transmission-speed storage means in advance, comparing said predetermined transmission speed set in said transmission-speed storage means in advance with said acquired transmission-speed information on a transmission speed set in another node connected to said network and carrying out transmission-speed-setting/updating processing to update a transmission speed stored in said transmission-speed storage means on the basis of a result of comparison.

2. A communication control unit according to claim 1 wherein said transmission-speed-setting means compares a transmission speed set in said transmission-speed storage means with acquired transmission-speed information on a transmission speed set in another node connected to said network and, if said transmission speed described in said acquired transmission-speed information is found lower than said transmission speed set in said transmission-speed storage means, said transmission speed described in said acquired transmission-speed information is used for updating said transmission speed set in said transmission-speed storage means.

3. A communication control unit according to claim 1 wherein:
said network is a network conforming to IEEE-1394 specifications;
said transmission-speed-information-acquiring means acquires a self-ID packet from each of said nodes connected to said network right after occurrence of a bus-reset prescribed in said IEEE-1394 specifications; and
every time said transmission-speed-information-acquiring means acquires a self-ID packet from any one of said nodes, said transmission-speed-setting means carries out transmission-speed-setting/updating processing to update setting of a transmission speed stored in said transmission-speed storage means by using transmission-speed information included in said self-ID packet.

4. A communication control unit according to claim 1 wherein said transmission-speed-information-acquiring means comprises:
a node-identification-information-receiving means for receiving information on a node identification used for identifying another node from said other node transmitting said information in accordance with a predetermined protocol; and
a transmission-speed-information-extracting means for extracting transmission-speed information on a transmission speed which said other node is capable to keep up with, from said information on a node identification.

5. A communication control unit according to claim 4 wherein said network is a network conforming to IEEE-1394 specifications; and
said information on a node identification is included in a self-ID packet prescribed by said IEEE-1394 specifications.

6. A communication control method adopted by a communication control unit mounted on an information-processing apparatus communicating with other apparatuses each serving as a node of a network through the network connecting said apparatuses with each other and used for controlling communications between said information-processing apparatus with said other apparatuses through said network, said communication control method comprising the steps of:
setting a transmission speed at which data is to be communicated with other nodes connected to said network in advance;
acquiring transmission-speed information on a transmission speed set in another node connected to said network for communicating data from said other node;
comparing said predetermined transmission speed set in advance with said acquired transmission-speed information on a transmission speed set for communicating data in said other node;
selecting an optimum transmission speed in accordance with a result of comparison and, if necessary, setting said selected optimum transmission speed to update said predetermined transmission speed set in advance; and
repeatedly carrying out the processing starting with the step of acquiring transmission-speed information on a transmission speed if there is a further node, from which transmission-speed information on a transmission speed has not been acquired.
